(19) United States
(12) Patent Application Publication
(10) Pub. No.: US 2010/0101234 A1
(43) Pub. Date: Apr. 29, 2010

(54) Evaporative Cooler and Use Thereof and Gas Turbine System Featuring an Evaporative Cooler

(76) Inventors: Jens Birkner, Oberhausen (DE); Walter David, Mulheim an der Ruhr (DE); Rudolf Gensler, Singapore (SG); Arne Grassmann, Essen (DE); Knut Halberstadt, Mulheim an der Ruhr (DE); Beate Heimberg, Haltern (DE); Bora Kocdemir, Essen (DE); Rainer Nies, Uttenreuth (DE); Jörg Schürhoff, Mulheim a.d. Ruhr (DE); Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/525,334

(22) PCT Filed: Jan. 30, 2008
(86) PCT No.: PCT/EP08/51127

§ 371 Date: Jul. 31, 2009

(30) Foreign Application Priority Data
Feb. 2, 2007 (EP) 07002345.2

(51) Int. Cl. F02C 7/14; F25B 39/02

(52) U.S. Cl. 60/806; 62/515

(57) ABSTRACT

An evaporative cooler for cooling a gas stream, in particular an air stream, including a number of cooling elements located in a flow channel, is provided. A liquid, preferably water, is supplied by a feed device and will be vaporized or evaporated. In one aspect, the surface of at least one of the cooling elements has hydrophilic properties, at least in one sub-region designed to form a liquid film.

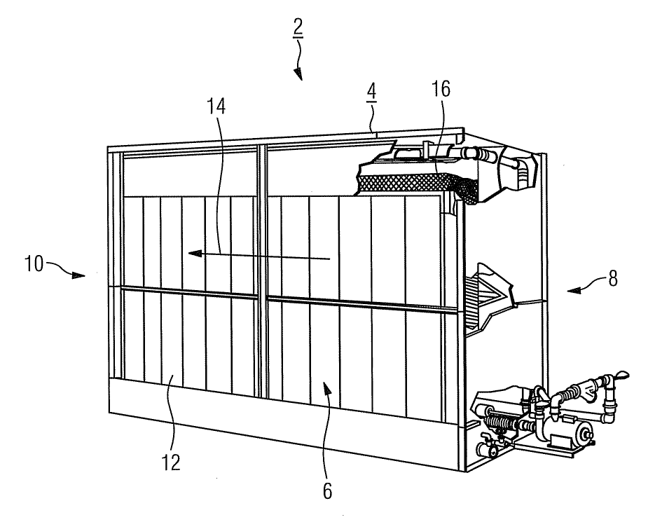

### CROSS REFERENCE TO RELATED APPLICATIONS

This application is the US National Stage of International Application No. PCT/EP2008/051127, filed Jan. 30, 2008 and claims the benefit thereof. The International Application claims the benefits of European Patent Office application No. 07002345.2 EP filed Feb. 2, 2007, both of the applications are incorporated by reference herein in their entirety.

### FIELD OF INVENTION

The invention relates to an evaporative cooler for cooling a gas stream, in particular an air stream, comprising a number of cooling elements which are arranged in a flow channel and, by means of a feed device, can be supplied with a liquid (preferably water) that is to be evaporated or vaporized. The invention also relates to a use of such an evaporative cooler and to a gas turbine system featuring an evaporative cooler.

### BACKGROUND OF INVENTION

The efficiency of the energy conversion in a gas turbine, and in particular its power output, depend inter alia on the intake temperature of the combustion air which is supplied to the combustion chamber via a compressor. As a rule, the lower the temperature of the air that is drawn in from the environment, the higher the efficiency of the compressor. The increased overall power output of the gas turbine can be traced back to the higher density of the cooler incoming air, and the greater mass flows of cooling air that can therefore be achieved. For this reason, the energy yield that can be achieved is usually considerably lower during the summer months than in winter. Accordingly, it is often possible clearly to increase the overall power output and the overall efficiency of a gas turbine by cooling the intake air, even taking into consideration the energy that is required for said cooling. The reduction in nitrogen oxide and/or CO₂ emissions can also be a positive side effect for the environment in this case.

Particularly in regions or on sites where the relative humidity of the surrounding air is comparatively low, the temperature of the intake air can be reduced in a relatively effective manner by applying the principle of evaporative cooling, and the efficiency and power output of a gas turbine can therefore be increased: as a result of being sprayed or distributed over large surfaces, a liquid—preferably water—evaporates in dry warm air in significant quantities. The required evaporation energy is taken from the surrounding air, which consequently cools. Depending on site and system, temperature differences of 5 K to 20 K are achieved in this way. At the same time, the humidity content of the air increases. Although the investment costs for such cooling systems are not insignificant, amortization periods of 1 to 3 years are nonetheless typical, and this has already led to an increased use of these systems.

In comparison with immediate and direct humidification of the intake air by means of spraying water into the air stream, e.g. using spray grids which are arranged ahead of the compressor inlet, evaporative cooling causes the water to be absorbed by the air by means of adiabatic vaporization or evaporation. This significantly reduces the risk of excessive spraying or over-saturation with water as opposed to air humidification. The principle of evaporative cooling for the purpose of reducing the intake temperature in the case of a gas turbine is usually technically implemented and realized in the form of evaporative coolers having honeycombed cooling elements which are situated e.g. ahead of or between the filter stages of an inlet filter for the fresh air. For this, a number of cooling elements or cooling sheets, these being also sometimes referred to as trickle sheets or downflow sheets and being arranged in the form of a cascade and usually being vertical, are supplied (e.g. sprinkled or sprayed) with water from above by means of a suitable feed device, such that the water runs down each element or sheet, ideally forming a film of water.

The intake air is ducted perpendicularly relative to this (in a so-called cross flow), and within a flow channel which is delimited by a number of housing walls. Some of the water flowing down is vaporized or evaporated by the comparatively warm intake air entering the evaporative cooler, thereby reducing the temperature of the air stream which leaves the cooling apparatus. The excess unevaporated water is collected at the foot of the cooling sheets and pumped back to the starting point by means of a low-pressure pump system, thereby producing an open cascade-type cooling water cycle overall.

So-called falling-film vaporizers are constructed in a similar manner to evaporative coolers, though their principal design objective is usually the generation of vapor rather than the cooling of a gas stream, and usually have a number of downflow sheets or downflow tubes, which are supplied with the water to be vaporized and are heated internally by means of an electrical heating device.

The cooling elements or cooling sheets of conventional evaporative coolers are usually manufactured from a special stainless steel, but can also be manufactured from e.g. plastic or paper-based materials, wherein the distribution of the supplied water on the available surface is relatively poor and uneven. If the whole surface of the relevant cooling element is to be used for evaporation, i.e. for effective cooling of the incoming air stream, sprinkling with a large excess of water is required. This results in relatively thick water films. However, in the case of thick water films, the probability increases that water is swept up by the airflow and that drops reach the blading of the gas turbine (particularly its compressor), which can result in undesirable erosive effects.

In all evaporative coolers or vapor coolers featuring an open cooling water cycle, it is therefore problematic in practice to set the correct water quantity, such that water drops are not swept into the blading, but sufficient water is nonetheless introduced into the evaporative cooler to ensure optimal cooling of the intake air. In the context of a conservative design which is conceived for safety, the water volume is generally set such that any impingement of drops is avoided as a prerequisite. In this case, the theoretically achievable cooling potential is not necessarily realized, since the evaporation or vaporization surface is not optimally utilized.

### SUMMARY OF INVENTION

The invention therefore addresses the problem of specifying an evaporative cooler of the type described in the introduction, providing non-critical operating performance and ease of use, which achieves a particularly high level of efficiency with regard to vaporization or evaporation of the supplied cooling liquid, and hence has a particularly significant cooling effect on the gaseous flow medium (particularly air) that flows through it. In particular, when using such an evaporative cooler as an intake cooler for a gas turbine, the erosion danger for the system components that are connected downstream on the flow medium side, especially the compressor blades, is limited. Also specified is a gas turbine system which features such an evaporative cooler and has a particularly high level of efficiency and a high overall power output.

In relation to the evaporative cooler, the problem is inventively solved in that the surface of at least one of the cooling elements has permanently hydrophilic properties, at least in a subregion which is specified for forming a liquid film.

The invention is based on the idea that the liquid film which is to form on the surface, said liquid film being made of the liquid (particularly water) that will evaporate or vaporize, should be so thick that, despite the actually desired loss of liquid due to evaporation or vaporization, there is no break in the liquid film at any point on the wetted surface. This would actually cause a decrease in vaporization and hence a reduction also in the achievable cooling effect. On the other hand, for the purpose of effective evaporation of vaporization, the liquid film should be no thicker than is absolutely necessary. This applies in particular to those evaporative coolers which are used for cooling the intake air stream of a gas turbine, in order to minimize the danger of dragging liquid droplets into the compressor blading.

In order to ensure that it is easy and unproblematic to provide such conditions, even in the event of irregular liquid feed or sprinkling, the surface of the usually honeycombed cooling elements or cooling sheets should be manufactured such that, by virtue of the specific type of liquid/solid interaction, a particularly even and homogenous liquid film is formed to some extent automatically, or that the formation of such a film is at least facilitated. In this case, if possible, the whole available surface of the cooling elements should be used, i.e. wetted by the liquid that is to evaporate.

According to the concept proposed here, the wettability of the cooling elements is improved by means of a surface that has been configured or modified such that it is intentionally hydrophilic (attractive to water), at least in the vicinity of the relevant wetting region. The corresponding treatment of the surfaces for the purpose of generating the hydrophilic properties is known as hydrophilization. As a result of this, a drop of liquid which comes into contact with the hydrophilized surface spreads out in the manner of a flat disc or flat spherical cap or, in the case of an inclined or vertical arrangement of the relevant cooling element, runs down in flat strips and adheres particularly well to the surface in this way. Any sweeping up by the flow of gas or air is reliably prevented due to this good adhesive effect. In comparison with an untreated or unmodified surface, a significantly smaller excess of water is required to achieve complete wetting of the surface of the cooling elements, thereby clearly reducing the required film thickness and helping to reduce the danger of liquid drops becoming detached or swept up.

As a quantitative measure for the hydrophelia of the surfaces treated thus, it is possible in this case to use the so-called contact angle which a liquid drop on the surface of the cooling element forms with the same. In general, hydrophilic surfaces have a contact angle of less than 90° in relation to water. However, the treated surface of the relevant cooling elements preferably has a contact angle of less than 40° relative to water, in particular less than 20° and, in a particularly preferred embodiment, less than 10°. The hydrophilization method is preferably selected such that the hydrophilic properties of the treated surfaces are as permanent or long-lasting as possible during the subsequent service life, such that the originally set contact angle does not increase or increases only insignificantly.

The surfaces of all walls and modules of the evaporative cooler, which support the vaporization or evaporation process as a result of being supplied with liquid, are advantageously hydrophilized irrespective of their shape, arrangement or orientation, and irrespective of the substrate material concerned. For example, in addition to the honeycombed cooling elements fitted in the flow channel, the internal wall sections of the cooler housing, which delimit the flow channel for the gaseous flow medium, can also be configured such that they are supplied with water and equipped with a surface of specifically hydrophilic design.

In an advantageous embodiment, the relevant cooling element comprises a main body, e.g. made of a metallic material, which is coated with a hydrophilic surface layer in the context of a suitably selected coating method before installation in the evaporative cooler or before the evaporative cooler becomes operational.

A first coating method is the so-called sol-gel method, which gives particularly advantageous results and, in particular, results in small contact angles in relation to water.

The term “sol-gel coating” is initially understood to mean any coating which is deposited on a metallic, ceramic or even plastic substrate material in the context of a so-called sol-gel process. During the course of a sol-gel method, a colloidal suspension or dispersion of solid particles having a small diameter—typically 1 nm to approximately 100 nm (so-called nanoparticles)—in a water or organic solvent is usually transformed into an amorphous nanostructured gel state by means of a sol-gel transition (gelation) in a first step. The sol-gel transformation results in a three-dimensional networking of the nanoparticles in the solvent, thereby giving the gel solid properties. In a second step, the gel or the gel coating which is deposited on the substrate material is then cured (sintered) by means of heat treatment or by photochemical means, and consequently transformed into a material or a stable and durable coating which has ceramic or glass-like properties.

Source materials (so-called precursors) for manufacturing the colloidal coating solution (so-called sol) typically include, for example, tetraethoxysilane, tetramethylorthosilicate, sodium silicate or glycol ester, and various other metal-organic polymers, in particular metal alkoxides and/or metal esters. By adding additional organic molecules having various functional groups and/or by adding anorganic microparticles and/or nanoparticles, the chemical and physical properties of the subsequent coating can be selectively influenced in a multiplicity of easily controllable and verifiable ways. In the application scenario described here, the manufacture of a coating having the most hydrophilic surface possible is a principal design objective in the selection of the precursors for the colloidal solution. Secondary objectives might be, for example, good adhesion to the substrate, high scratch resistance, high temperature resistance, or also the attainment of good erosion protection for the usually metallic substrate which is covered by the coating.

The sol which is produced, normally as a result of a multiplicity of hydrolysis or polymerization reactions in this case, is applied to the substrate by means of spraying, dipping or spinning. The so-called dip-coating method is preferably used for coating more extensive and largely plane surfaces. The substrate that is to be coated, in particular the relevant cooling element here, is dipped into the sol and withdrawn again at a constant speed in this case, such that a liquid sol film remains stuck to the substrate surface. After drying for short time, the initially liquid sol film transforms into a gel film which is more or less solid and can then be subjected to postheating in an oxygen-containing atmosphere (air), for example. At temperatures of up to approximately 400° C., the organic components of the metal-organic polymers decompose and escape, mainly in the form of carbon dioxide and water. The remaining amorphous and nanoporous metal oxide film starts to sinter at temperatures above 500° C. Nucleation and critical growth occur at the same time, such that a nanocrystalline impervious oxide-ceramic film is produced from the amorphous and porous gel film.

The chemical sol composition, the layer deposition conditions (e.g. extraction speed) and the heat treatment parameters (heating speed, temperature, duration of exposure) have a significant influence on the layer properties and are set according to the objectives described above. As a result of the development of covalent bonds between layer and substrate, high adhesion values are achieved, this being advantageous in relation to a long service life and high mechanical endurance of the coating.

As an alternative or in addition to the purely oxide-ceramic sol-gel layers, it is also possible to use organic-anorganic hybrid layers, by means of which greater layer thicknesses and higher ductility values can generally be achieved. In specific cases, the treatment temperatures can also be considerably less than 300° C. As an alternative or in addition to the heat treatment, provision can also be made for curing by means of UV light or visible light.

As an alternative to a sol-gel method, other coating or treatment methods can be used for hydrophilization of the evaporation or vaporization surfaces, and are in some cases easier to apply, incur lower costs, and result in fewer undesired side products, e.g. solvents, being released.

For example, provision can be made for applying a layer of suitable wet-chemical paint on a main body of a cooling element, thereby creating the desired hydrophilic surface. In this context, it is conceivable to use e.g. acrylic paints or paints based on polyester resins, polysiloxanes, epoxides, polyurethanes or polysilazanes. The polarity of the surface is a prerequisite for hydrophelia and therefore good wettability by water. Polar groups in paint resins contribute to an increase in the surface energy and hence to better wettability of the surface by water. The approaches for manufacturing hydrophilic paints therefore rely on the inclusion of corresponding chemical groups, such as e.g. —OH, —COOH, —NH₂, and —SH. In addition, a paint can be made hydrophilic by means of adding special filler particles, in particular hydrophilic aerosils. Corresponding details are already known to a person skilled in the art from other applications and fields of use for such paints, including e.g. anti-misting coatings on spectacles, torch lenses and helmet visors. In addition, certain medical products are equipped with such hydrophilic coatings, for example.

A further possibility for generating the desired surface properties is offered by the various methods of atmospheric or vacuum-assisted plasma coating. Using so-called Chemical Vapor Deposition (CVD), reactive silane compounds can be deposited on surfaces in the form of a layer. In this case, the deposition of the solid components takes place as a result of a chemical reaction from the gas phase at the heated surface of the substrate. Consequently, hydrophilic coats can also be realized using corresponding silicane precursors. The deposition can take place both in the low-pressure plasma and under atmospheric conditions. At present, such methods are also used in the field of anti-misting coatings or in the context of medical applications. Layers can also be deposited under vacuum conditions by means of so-called Physical Vapor Deposition (PVD), in particular metallic or metal-organic coats on plastic substrates, which result in greater surface energy and therefore better wettability of the substrate. In contrast with the CVD method, the PVD method provides for the layer to be formed directly by condensation of a material vapor of the source material.

A further possibility for selective modification of the surface properties of a material, in particular for the purpose of increasing the surface energy and hydrophilization, is provided by the flame coating or flame-pyrolytic deposition of an amorphous highly-cured silicate on the substrate material layer by means of combustible silane-containing gases (also known as the Pyrosil method). For this, the surface to be treated is passed through the oxidizing region of a gas flame into which a silicon-containing substance (so-called precursor) has been previously dosed as defined. Silicate layers based on this method are usually between 20 nm and 40 nm thick, and consequently provide effective hydrophilization of the surface.

Furthermore, various methods exist which can be grouped under the generic term or keyword “physical oxidation”, and which increase the polar part of the surface energy by a selective oxidation of surfaces and therefore favor the wettability by water. In this regard, for example, reactive plasmas have an oxidizing effect, e.g. in the context of a plasma treatment in the presence of oxygen, argon or air. These processes can be carried out both in a vacuum and under atmospheric conditions. In the case of methods for corona discharge or corona treatment, which likewise belong to the group of physical oxidation and are commonly used in plastics technology to improve the printability and bonding of plastic film, for example, the substrate is exposed to an electrical discharge, wherein a gas (e.g. air) surrounding the electrodes and the substrate is ionized. Flame treatment is also a method for oxidization of plastic surfaces and allows hydrophilic properties to be established. By contrast, electrolytic oxidation is primarily suitable for the modification of aluminum surfaces.

The polarity and hence the hydrophelia of surfaces can also be increased by means of treatment using strongly oxidizing liquids, e.g. hydrogen peroxide, or strongly oxidizing gases, e.g. ozone. For example, ozonization or fluorination are currently customary in the field of plastics technology, e.g. in film technology and in the treatment of plastic tanks made of plastic. Such methods can be referred to collectively as “chemical oxidation”.

Finally, in the case of a cooling element of an evaporative cooler, provision can also be made for establishing the desired hydrophilic surface properties by means of chemical pickling or etching, or by phosphating the surface. Pickling, which is currently used primarily for removing impurities such as rust and scaling, etc., is understood to mean the treatment of metallic surfaces using acids, e.g. hydrochloric acid, sulfuric acid, nitric acid (acid pickling), or using lyes, e.g. sodium hydroxide solution (alkaline pickling). In the case of phosphating, the metallic substrates are treated using a water-based phosphate solution. In this case, anorganic conversion layers which have corrosion-inhibiting effects and can be easily coated, i.e. are hydrophilic, are produced on the metal surface as a result of chemical reactions.

The particular advantage of the invention is that, as a result of the selective surface treatment and hydrophilization of the modules and cooling elements (in particular of honeycombed cooling sheets) which are provided for liquid vaporization or evaporation in an evaporative cooler, an enlargement or more efficient utilization of the active heat transfer surface is achieved by virtue of the improved wettability. When such an evaporative cooler is used to cool a gas stream, e.g. in an intake cooler of a gas turbine, particularly good cooling effects can be achieved, even when using a comparatively modest supply of liquid. At the same time, any sweeping up of liquid drops by the gas flow is largely suppressed or prevented, thereby reducing the danger of e.g. corrosion and erosion for a thermal reciprocating engine or a thermal fluid-flow machine, in particular a gas turbine, which is arranged behind the evaporative cooler. As a result of the high efficiency of the intake cooler, the efficiency and the power yield of the subsequent gas turbine also increases.

A further advantage of the concept proposed here is that, as a result of the improved surface utilization, the installation depth of the evaporative cooler can be smaller than previously for the same cooling power. As a result of the reduced structural depth, it is possible to achieve a more compact design of the housing and hence a reduction in manufacturing costs. Moreover, less pressure loss is experienced in the intake section than was previously the case.

The concept of hydrophilization of vaporization or evaporation surfaces can also be advantageously applied to increase efficiency in the case of falling-film vaporizers, whose primary purpose is not the cooling of a gas stream but the production of vapor itself, e.g. in the process engineering for the distillation of liquid mixtures, etc. Instead of or in addition to heating by means of a hot gas stream, e.g. electrical heating of downflow sheets or tubes can also be provided in this case.

### BRIEF DESCRIPTION OF THE DRAWINGS

An exemplary embodiment of the invention is explained in greater detail with reference to a drawing, in which the figure shows a partly sectional view of an evaporative cooler.

### DETAILED DESCRIPTION OF INVENTION

The evaporative cooler 2 which is illustrated in the figure is used as an intake cooler for the purpose of cooling intake air that is drawn in from the environment and is supplied to a compressor of a gas turbine (not shown). For this, it features a flow channel 6, this being surrounded by a closed housing 4 and comprising an air inlet 8 and an air outlet 10, in which is arranged a plurality of cooling elements 12 or cooling sheets, these being combined into groups or cooling modules in each case. The flat cooling elements 12 are in each case oriented vertically and parallel to the flow direction 14 of the air flow that forms during operation, and can be supplied with water on both sides via a feed device 16 which is arranged in the cover region of the housing 4 or on the top side of the relevant cooling element 12. A water film running from top to bottom therefore forms on both the “front side” and on the “rear side” of the relevant cooling element 12 during operation, and the intake air which is carried through the flow channel 6 flows over said water film. In accordance with the principle of evaporative cooling, some of the downward flowing water evaporates or vaporizes in this case, whereby the relative humidity of the air flow increases and its temperature drops. The unvaporized part of the water flowing down the cooling elements 12 gathers in the base region in a collection apparatus, which is not illustrated in further detail here, and is then returned to the feed device in the manner of an open cycle by means of a pump that is not shown here, wherein the loss of liquid due to evaporation in the cycle is equalized by adding fresh water, preferably normal mains water.

The drier the (surrounding) air that is drawn into the evaporative cooler 2, the greater the cooling effect that can be achieved. Furthermore, in order to achieve a high level of efficiency, ideally the whole of the available surface of the cooling elements 12 should be exploited as an evaporation surface, wherein the water film that fauns should not break at any location despite the desired evaporation. On the other hand, the quantity of water that is supplied per time unit should be kept as small as possible, such that no water drops become detached from the cooling elements 12, wherein said water drops could otherwise be swept up via the air flow into the blading of the compressor that is connected behind the evaporative cooler 2, and could cause erosion damage there.

In order to reconcile these conflicting design objectives, the cooling elements 12 of the present evaporative cooler 2 are configured to allow particularly good wettability using the cooling liquid, in particular water, by means of a sol-gel coating which is applied to the surface of the base material, this being a special steel in the exemplary embodiment here. In particular, under standard or normal operating conditions, e.g. given an incoming air temperature of 15° C. and an air pressure of 1013 mbar, contact angles of less than 40°, preferably less than 20° or even less than 10°, are achieved in relation to water. The hydrophilic coating results in a particularly uniform distribution of the water on the surface of the cooling elements 12, even when relatively modest quantities of water are supplied. The formation of homogeneous and relatively thin water films is assisted, even in the case of uneven flooding and high levels of evaporation or vaporization, and the danger of water drops being swept up by the air flow is reduced at the same time.

It is understood from the above explanations that the sol-gel coating represents an example of a whole range of other methods which can be selectively applied to bring about a hydrophilization of the cooling element 12 surfaces that are relevant for the evaporation. In particular, these also include coating with hydrophilic wet-chemical paints, plasma coating, flame coating, physical oxidation and chemical oxidation of the surfaces, and chemical pickling and etching using acids or lyes. It is obvious that the selection of a particularly suitable hydrophilization method is influenced by the (substrate) material from which the cooling elements 12 are manufactured, but also by other considerations such as e.g. effort and cost, durability of the coating or modified surface under operating conditions, etc. Methods which do not require expensive vacuum equipment and can therefore also be used very flexibly and locally, i.e. on site, are particularly preferred.

1.-13. (canceled)

14. An evaporative cooler for cooling a gas stream, comprising:
a plurality of cooling elements;
a flow channel; and
a feed device,
wherein the plurality of cooling elements are arranged in the flow channel,
wherein the feed device supplies a liquid to the plurality of cooling elements,
wherein the liquid is evaporated or vaporized, and
wherein the plurality of cooling elements comprise a plurality of cooling sheets, a surface a cooling sheet has hydrophilic properties at least in a subregion which is specified for forming a liquid film.

15. The evaporative cooler as claimed in claim 14, wherein the gas stream is an air stream.

16. The evaporative cooler as claimed in claim 14, wherein the liquid is water.

17. The evaporative cooler as claimed in claim 14, wherein the plurality of cooling sheets stand vertically and are arranged in a form of a cascade.

18. The evaporative cooler as claimed in claim 14, wherein a contact angle of the hydrophilic surface is less than 20° relative to the liquid.

19. The evaporative cooler as claimed in claim 18, wherein the contact angle of the hydrophilic surface is less than 10°.

20. The evaporative cooler as claimed in claim 14, wherein the plurality of cooling sheets are in a honeycombed shape.

21. The evaporative cooler as claimed in claim 14, wherein the plurality of internal wall sections of a cooler housing are configured such that the plurality of internal wall sections are supplied with water and include a hydrophilic surface.

22. The evaporative cooler as claimed in claim 14, wherein at least one of the plurality of cooling elements comprises a main body including a hydrophilic surface coating.

23. The evaporative cooler as claimed in claim 14, wherein at least one of the cooling elements comprises a main body equipped with a hydrophilic surface layer that is produced using a sol-gel method.

24. The evaporative cooler as claimed in claim 14, wherein at least one of the plurality of cooling elements comprises the main body equipped with the hydrophilic surface layer that is produced by applying a wet-chemical paint.

25. The evaporative cooler as claimed in claim 14, wherein at least one of the plurality of cooling elements comprises the main body equipped with the hydrophilic surface layer that is produced using plasma coating.

26. The evaporative cooler as claimed in claim 14, wherein at least one of the plurality of cooling elements comprises the main body equipped with the hydrophilic surface layer that is produced using flame coating.

27. The evaporative cooler as claimed in claim 14, wherein at least one of the plurality of cooling elements comprises the main body with the surface that has been hydrophilized using physical oxidation, and
wherein the physical oxidation method is selected from the group consisting of atmospheric or vacuum-based plasma treatment, electrolytic oxidation, corona discharge and flame treatment.

28. The evaporative cooler as claimed in claim 14,
wherein at least one of the cooling elements has the main body with the surface that has been hydrophilized using chemical oxidation, and
wherein an oxidizing agent used for the chemical oxidation is selected from the group consisting of ozone, hydrogen peroxide and fluorine.

29. The evaporative cooler as claimed in claim 14, wherein at least one of the cooling elements comprises the main body with the surface that has been hydrophilized by etching or pickling using an acid or a lye.

30. A gas turbine system, comprising:
a compressor;
a combustion chamber;
a gas turbine; and
an evaporative cooler, comprising:
a plurality of cooling elements,
a flow channel, and
a feed device;
wherein the plurality of cooling elements are arranged in the flow channel,
wherein the feed device supplies a liquid to the plurality of cooling elements,
wherein the liquid is evaporated or vaporized, and
wherein the plurality of cooling elements comprise a plurality of cooling sheets, a surface of the plurality of cooling sheets has hydrophilic properties at least in a subregion which is specified for forming a liquid film.
wherein the evaporative cooler is connected ahead of the compressor on an intake side.

31. The gas turbine as claimed in claim 30, wherein the plurality of cooling sheets stand vertically and are arranged in a form of a cascade.

32. The gas turbine as claimed in claim 30, wherein a contact angle of the hydrophilic surface is less than 20° relative to the liquid.

33. The gas turbine as claimed in claim 30, wherein at least one of the plurality of cooling elements comprises a main body including a hydrophilic surface coating.
